(19) United States
(12) Patent Application Publication
(10) Pub. No.: US 2013/0180908 A1
(43) Pub. Date: Jul. 18, 2013

(54) Filter Backflush System for Entrained Filtration Elements

(71) Applicant: WORLD WIDE WATER SOLUTIONS, Gilbert, AZ (US)

(72) Inventor: Dennis Chancellor, Gilbert, AZ (US)

(73) Assignee: WORLD WIDE WATER SOLUTIONS, Gilbert, AZ (US)

(21) Appl. No.: 13/744,267

(22) Filed: Jan. 17, 2013

Related U.S. Application Data
(60) Provisional application No. 61/587,561, filed on Jan. 17, 2012.

(51) Int. Cl. B01D 65/02

(52) U.S. Cl. CPC B01D 65/02
USPC 210/257.2; 210/321.69

(57) ABSTRACT

A backflush fluid line is configured to provide a backflush fluid, under a pressure, to a filtration membrane of an encapsulated filtration vessel. A control subsystem can be used to assist in determining when the vessel should be backflushed, and a plurality of valves can cooperate to switch between a filtration mode and a backflushing mode. In preferred embodiments the backflush fluid line can be configured to provide at least some of the backflush fluid to the vessel via the permeate port, and debris fluid exits the vessel via the feed fluid inlet port. Three-way valves are preferably used to control the fluid flows.

This application claims priority to U.S. provisional patent application Ser. No. 61/587,561 filed Jan. 17, 2012, the disclosure of which is incorporated herein in its entirety.

### FIELD OF THE INVENTION

The field of the invention is filtration systems.

### BACKGROUND

Reverse osmosis and other filters invariably become fouled over time. In traditional systems, cleaning a filter generally requires that the system must first be shut down to replace the filter. In larger systems that process can result in significant operating expense and downtime. In addition, large filters can be quite heavy, and where they are press-fitted into place, can be difficult to remove.

It is known in some instances to backflush a filter in situ, which reverses the usual flow of fluid across the filter membrane to eject solids blocking the membrane pores, and partly dislodges the cake that may have formed on the membrane surface. Backflushing, which can also be referred to as backwashing or backpulsing, and in a highly aggressive form can be called blowout, can reduce minimize downtime, and eliminate the costs associated with removing and replacing a filter. See, e.g., U.S. Pat. No. 4,678,564 to Moorehead et al.; U.S. Pat. No. 5,830,347 to Vollmer; and U.S. Patent Appl. No. 2009/0223895 to Zha et al. (publ. September 2009).

Moorehead and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Moorhead teaches a pressure-controlled, automated backflush system for reverse osmosis filters, and a multi-zoned filter that facilitates backflushing

Vollmer teaches an automated backflush system having a backflush impeller disposed within the permeate cavity of the filter.

Zha teaches an in situ backflushing system that uses either a high velocity gas or a high velocity liquid. Zha's contribution to the art appears to have been use of pressurized ejection of the dislodged waste rather than relying on gravity downdrain.

One issue is that all of the known prior art backflush systems utilize cartridge-based filtration apparatus. In April 2009, the current inventor filed a provisional patent application on an encapsulated filtration vessel, in which a pressure casing is formed about the filter element. The provisional application was superseded in part by WIPO patent application serial no. PCT/US10/30580 filed on Apr. 9, 2010. The disclosed vessel filters are effectively disposable, since the filter element cannot readily be replaced, and it is submitted that one of ordinary skill in the art would not think to backflush a disposable, encapsulated filtration vessel.

Thus, there is still a need for a backflush system for encapsulated filtration vessels.

### SUMMARY OF THE INVENTION

The inventive subject matter provides apparatus, systems and methods in a backflush fluid line is configured to provide a backflush fluid, under a pressure, to a filtration membrane of an encapsulated filtration vessel. A control subsystem can be used to assist in determining when the vessel should be backflushed, and a plurality of valves can cooperate to switch between a filtration mode and a backflushing mode.

In preferred embodiments the backflush fluid line can be configured to provide at least some of the backflush fluid to the vessel via the permeate port. Also in preferred embodiments, the backflush fluid line is configured to draw at least some of the backflush fluid from a permeate reservoir, and the pressure in the backflush fluid line is provided at least in part by gravity. In some embodiments the pressure in the backflush fluid line can be provided entirely by gravity, and in other embodiments the pressure in the backflush fluid line can be provided entirely or at least in part by a pump.

It is also preferred that a debris fluid resulting from a backflushing operation exits the vessel via the feed fluid port, and that the plurality of valves includes a first at least three-way valve that alternatively directs the feed fluid into the vessel, and debris fluid from to a reject line, and another a second least three-way valve that alternatively directs the bypass fluid to a reject line, and the backflush fluid into the vessel.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is a schematic of a conventional membrane filtration system configured for normal filtration.

FIG. 1B is a schematic of the filtration system of FIG. 1A, configured backflushing of the membrane.

FIG. 2A is a schematic of an encapsulated membrane filtration system with gravity fed backflushing, configured for normal filtration.

FIG. 2B is a schematic of the filtration system of FIG. 2A, configured for backflushing.

FIG. 3A is a schematic of an encapsulated membrane filtration system with pump assisted backflushing, configured for normal filtration.

FIG. 3B is a schematic of the filtration system of FIG. 3A, configured for backflushing.

FIG. 4 is a schematic of an alternative embodiment in which an encapsulated membrane filter has a feed water inlet on the top.

FIG. 5 is a schematic of another alternative embodiment, similar to FIG. 4, but with pump assisted backflushing.

### DETAILED DESCRIPTION

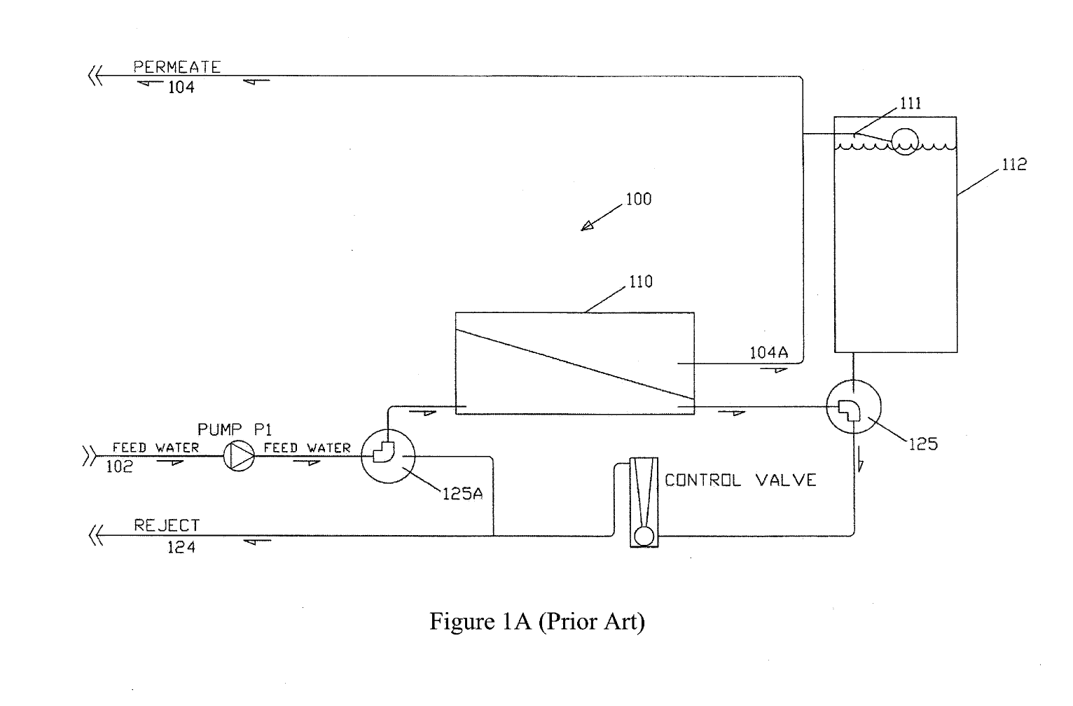

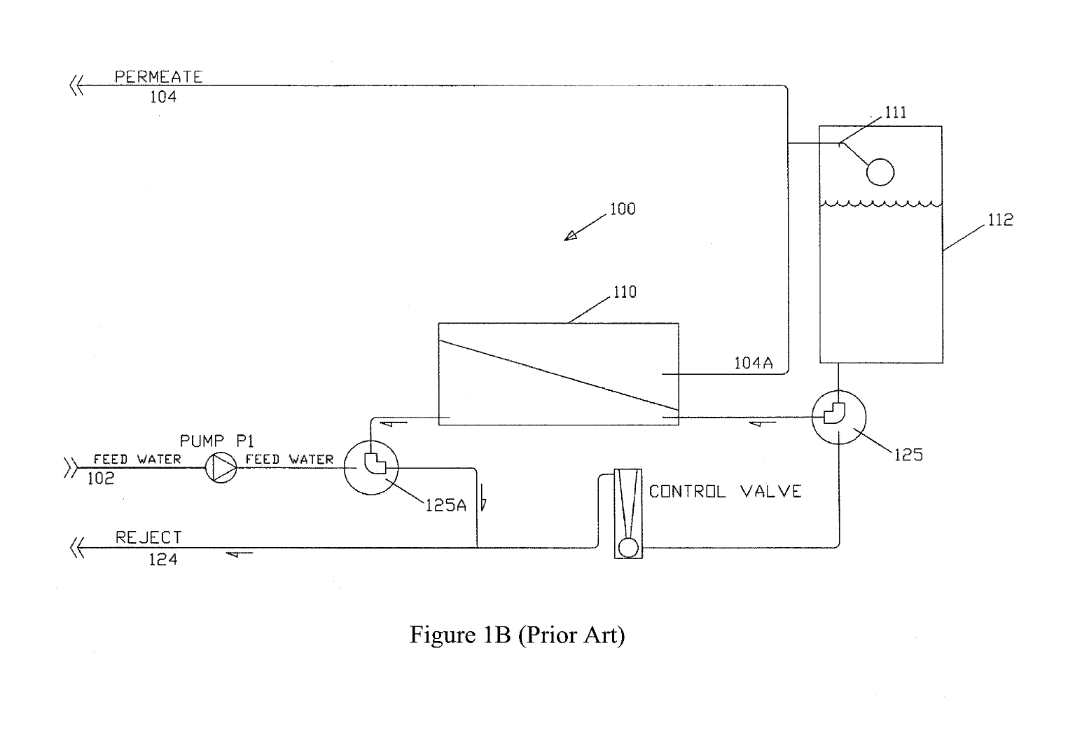

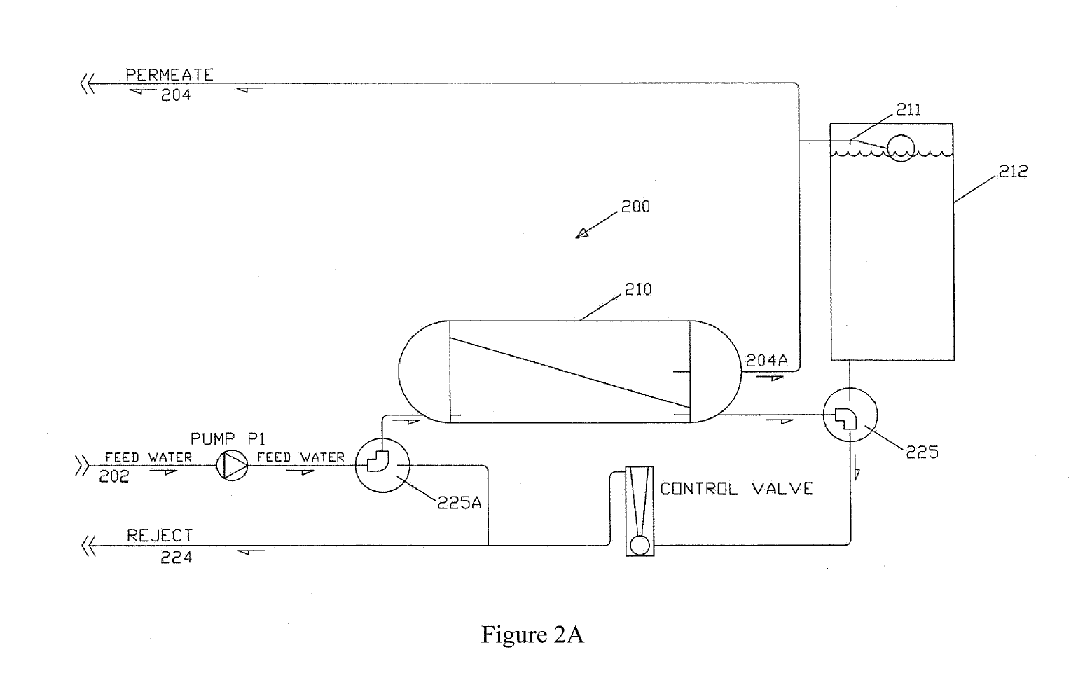

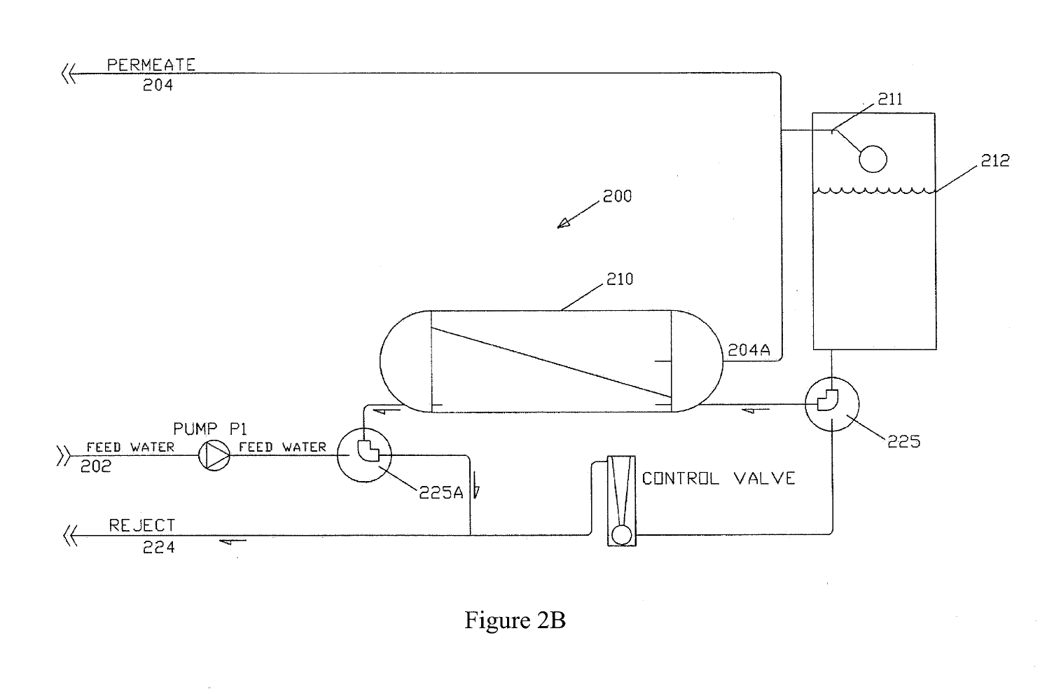

FIGS. 1A and 2B illustrate a conventional reverse osmosis system utilizing a gravity-powered backflush system. A feed water or other fluid is fed to the system along feed line 102, as assisted by pump P1. A three-way valve 125A directs the feed fluid to an entrained membrane vessel 110. During normal filtration, permeate exits entrained membrane vessel 110 along line 104A, and as needed, some of the permeate is used to fill permeate reservoir 112. Float subsystem 111 provides a cutoff so that permeate does not overfill the reservoir 112. Also during normal filtration, reject fluid exits entrained membrane vessel 110 along line 124, passing through valve 125.

During backflush, valves 125A and 125 are rotated so that permeate from the permeate reservoir 112 passes back into the entrained membrane vessel 110 through the permeate port along part of line 104A. What is then a debris fluid exits the entrained membrane vessel 110 via the feed fluid port, and is directed via valve P1 out of the system along part of line 124.

All such systems known to Applicants utilize a conventional membrane pressure vessel of some kind, in which replaceable filter elements are disposed within a pressure vessel. FIG. 1A shows the system configured for normal filtration, and FIG. 1B shows the system configured for backflushing. The reader may note that in FIG. 1B, the permeate reservoir 112 has been partially drained.

In FIGS. 2A and 2B, a filter backflush system is shown having an encapsulated, also referred to herein from as an entrained membrane vessel, (“EMV”) such as that described in WIPO patent application serial no. PCT/US10/30580 filed on Apr. 9, 2010, discussed above.

A feed water or other fluid is fed to the system along feed line 202, as assisted by pump P1. A three-way valve 225A directs the feed fluid to entrained membrane vessel 210. Permeate exits along line 204A, and as needed, some of the permeate is used to fill permeate reservoir 212. Float subsystem 211 provides a cutoff so that permeate does not overfill the reservoir 212.

During normal filtration, permeate exits entrained membrane vessel 210 along line 204A, and as needed, some of the permeate is used to fill permeate reservoir 212. Float subsystem 211 provides a cutoff so that permeate does not overfill the reservoir 212. Also during normal filtration, reject fluid exits entrained membrane vessel 210 along line 224, passing through valve 225.

During backflush, valves 225A and 225 are rotated so that permeate from the permeate reservoir 212 passes back into the EMV 210 through the permeate port along part of line 204A. What is then a debris fluid exits the EMV 210 via the feed fluid port, and is directed via valve P1 out of the system along part of line 224.

In preferred embodiments, three-way valves can be used, which reduce the overall complexity of the system, and ensure that the system is only in a backflush mode when desired. This is advantageous over traditional series of two-way valves because there are fewer valves to operate to change the system from filtration to backflushing. The three-way valves could be operated manually, or through an automated or semi-automated fashion through the use of pneumatic, hydraulic, or electrically operated valves, for example. It is further contemplated that valves regulating flow in four or more ways could alternatively be used. Such valves are referred to herein from time to time as “as least three-way” valves.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The EMV 210 is preferably disposed in a vertical position that is approximately parallel to the positioning of the permeate vessel and/or vessel holding treated back-purge fluids. Horizontal and other positions could also be used.

Contemplated systems can include one or more sensors to monitor flow rate within or to the EMV. If the flow rate falls below a predetermined threshold, an alert can be created and/or the back flushing system can be automatically initialized. It is further contemplated that the permeate can be flushed through the EMV at a pressure great enough to overcome backflow resistance and allow a rapid back flush by the flushing fluid through the EMV. This contemplated delta pressure may be about 15 psi. It is further anticipated that the pressure could vary depending on the size of the system, the amount of build-up, and the characteristics of the EMV(s), conduits, pumps, if any, and related components of the system.

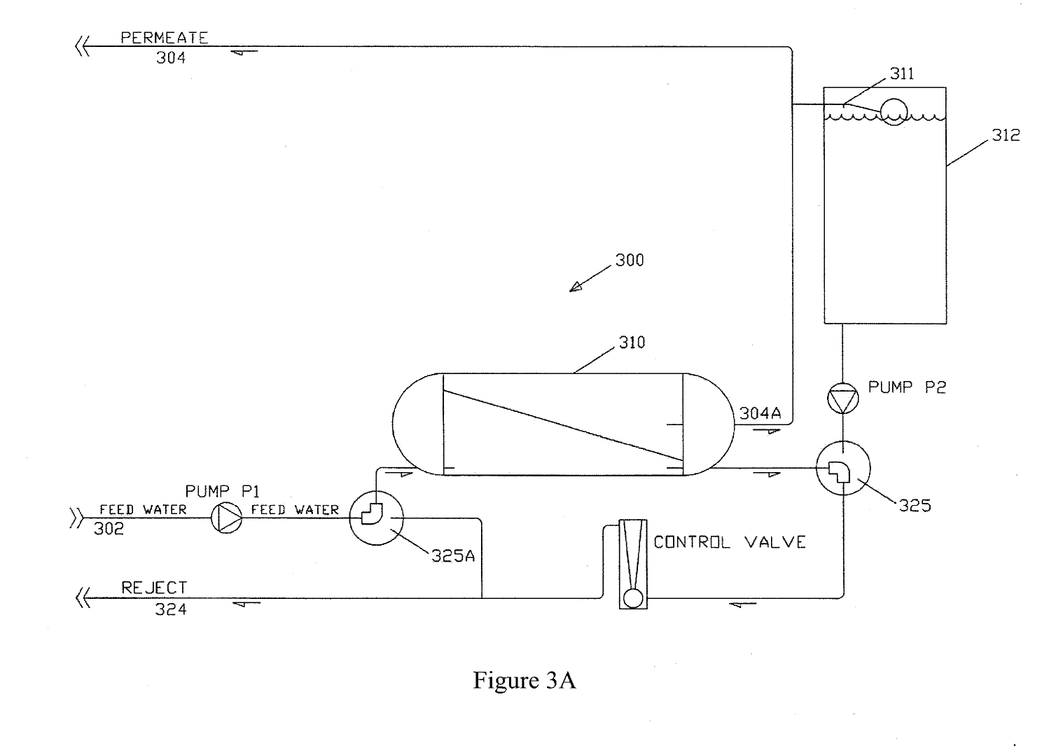

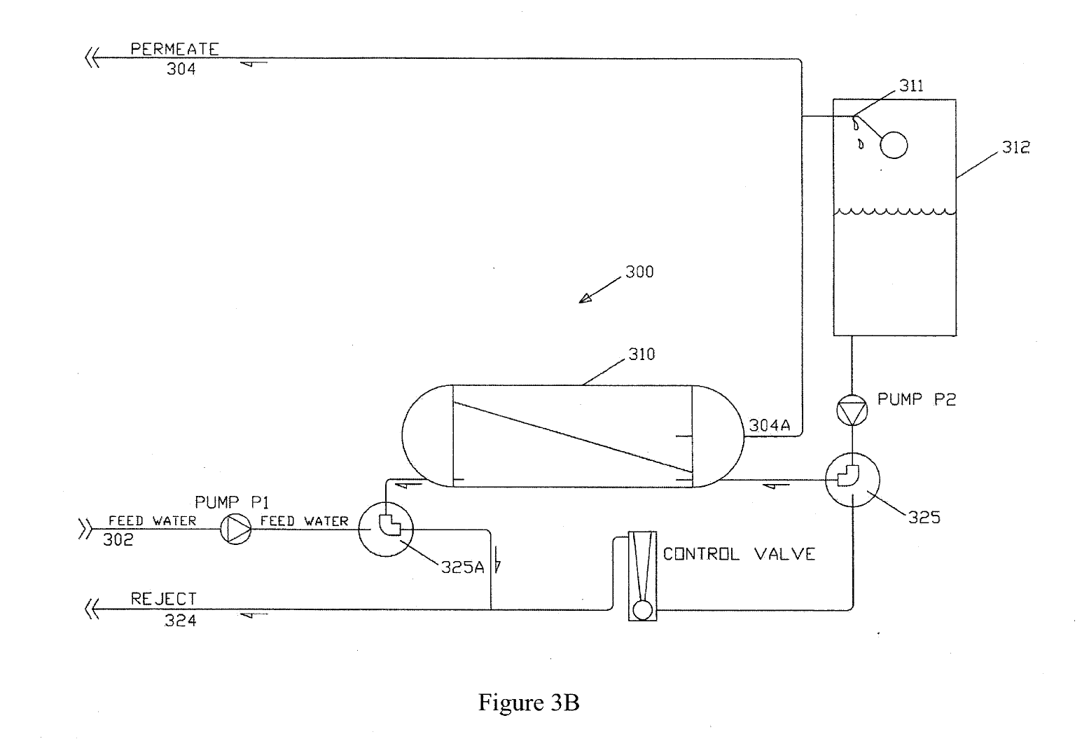

FIGS. 3A and 3B illustrate another embodiment of a backflush system for an EMV, which is similar to that depicted in FIGS. 2A and 2B, except that here the flow of permeate back into the EMV is assisted by pump P2.

A feed water or other fluid is fed to the system along feed line 302, as assisted by pump P1. A three-way valve 325A directs the feed fluid to entrained membrane vessel 310. Permeate exits along line 304A, and as needed, some of the permeate is used to fill permeate reservoir 312. Float subsystem 311 provides a cutoff so that permeate does not overfill the reservoir 312.

During normal filtration, permeate exits entrained membrane vessel 310 along line 304A, and as needed, some of the permeate is used to fill permeate reservoir 312. Float subsystem 311 provides a cutoff so that permeate does not overfill the reservoir 312. Also during normal filtration, reject fluid exits entrained membrane vessel 310 along line 324, passing through valve 325.

During backflush, valves 325A and 325 are rotated so that permeate from the permeate reservoir 312 passes back into the EMV 310 through the permeate port along part of line 304A, assisted by pump P2. What is then a debris fluid exits the EMV 310 via the feed fluid port, and is directed via valve P1 out of the system along part of line 324.

A preferred cycle pertaining only to the feed water channel includes first de-energizing the feed water pump P1. Next the three-way valves 325, 325A are rotated from the open position to the purge position. The back-purge pump P2 can then be energized and then de-energized once the backflushing is completed. Then the valves 325, 325A can be rotated from the purge position to the open position. Once the valves are in the open position, the feed water pump P1 can be re-energized.

Additional pressure can be added to the EMV permeate collection channel through an additional source (not shown) to thereby dislodge at least some of the accumulated matter lodged on the membrane surface of the EMV. The dislodged matter can be suspended within the feed water channel and later purged from the system during the normal back-purge cycle discussed above. The subsequent opened membrane surface advantageously allows an improved flux flow proportional to the effectiveness of the permeate purge cycle during normal membrane operations with feed water. Furthermore these higher flux rates will be near the levels of the designed maximum flux rate of the EMV.

A preferred cycle including the additional pressure source is as follows. First, the feed water pump is de-energized. Next, the permeate channel is energized to add a pressure pump and valves. The permeate additional pressure pump and valves can then be de-energized. The three-way valves can then be changed from an open position to a purge position. Next, the back-purge pump can be energized and de-energized when no longer needed. The three-way valves can then be changed back to the open position, and the feed water pump re-energized. This sequence of steps pertains only to the additional permeate channel, pressure cycle, and the EMV feed water channel.

The system can optionally include an actuated membrane drain down valve and an air supply valve (not shown), which can reduce most of the dilution of the incoming back-purge water by the remaining feed water trapped within the feed water channel of the EMV. Together, these additional components are referred to as the drain down cycle.

It is currently preferred that the following sequence of steps be used to backflush the system including the drain down cycle. First, the feed water pump is de-energized. Next, the additional pump and valves of the permeate channel are energized, and then de-energized when the backflushing is completed. Then, both of the membrane drain down valves can be energized to allow drainage of the backflush fluid. Once completed, the drain down valves can be de-energized. Next, the three-way valves can be rotated from an open position to a purge position, and the back-purge pump can then be energized. The pump can be de-energized when no longer needed, and the valves can then be rotated from the purge position to the open position. Finally, the feed water pump can be re-energized.

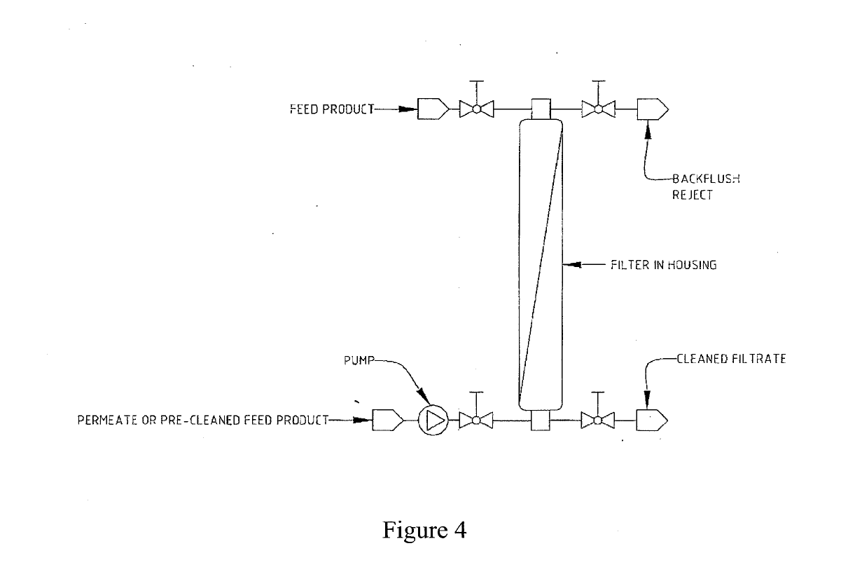

FIG. 4 illustrates top feed filtrate vessel that having some similarities to prior art devices having back-purge fluids. Here, however, the filter is an encapsulated membrane filter with the feed water inlet on the top. A back purge fluid is fed into a bottom of the filter housing. This back purge fluid will dislodge accumulated matter from the surface of the filter and flush the dislodged matter out from the system through an outlet at the top of the filter housing.

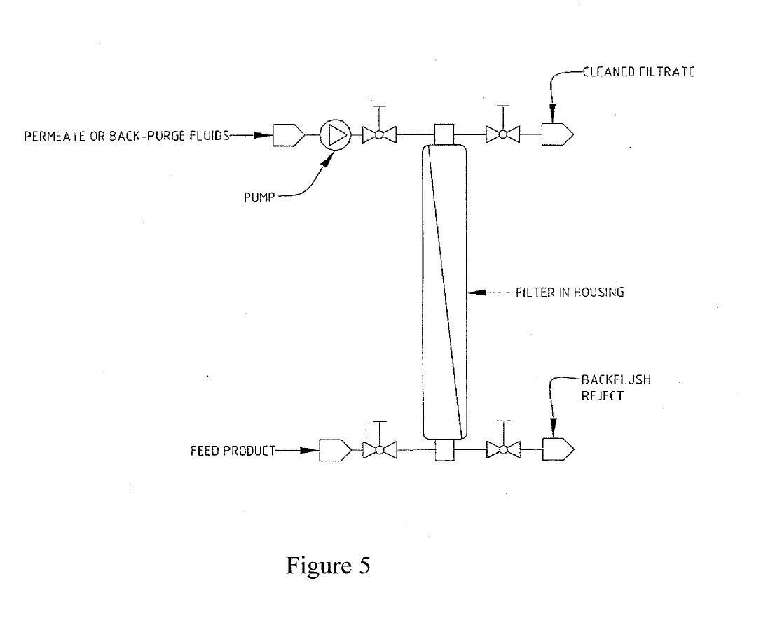

FIG. 5 is similar to FIG. 4 except that backflow of the permeate into the filter is assisted by a pump.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A filter system, comprising:
An encapsulated filter vessel having:
a filtration membrane;
a feed fluid port through which a feed fluid enters the vessel;
a permeate port through which a permeate exits the vessel; and
a reject port through which a bypass fluid exits the vessel;
a backflush fluid line configured to provide a backflush fluid to the filtration membrane under a pressure;
a control subsystem that assists in determining when the vessel should be backflushed; and
a plurality of valves that cooperate to switch between a filtration mode and a backflushing mode.

2. The filter system of claim 1, wherein the backflush fluid line is configured to provide at least some of the backflush fluid to the vessel via the permeate port.

3. The filter system of claim 1, wherein the backflush fluid line is configured to draw at least some of the backflush fluid from a permeate reservoir.

4. The filter system of claim 1, wherein the pressure in the backflush fluid line is provided at least in part by gravity.

5. The filter system of claim 1, wherein the pressure in the backflush fluid line is provided entirely by gravity.

6. The filter system of claim 1, wherein the pressure in the backflush fluid line is provided at least in part by a pump.

7. The filter system of claim 1, wherein a debris fluid resulting from a backflushing operation exits the vessel via the feed fluid port.

8. The filter system of claim 7, wherein the plurality of valves includes an at least three-way valve that alternatively directs the feed fluid into the vessel, and debris fluid from to a reject line.

9. The filter system of claim 7, wherein the plurality of valves includes an at least three-way valve that alternatively directs the bypass fluid to a reject line, and the backflush fluid into the vessel.
